(19) United States
(12) Patent Application Publication
(10) Pub. No.: US 2002/0101999 A1
(43) Pub. Date: Aug. 1, 2002

(54) Differential audio device

(76) Inventor: Kuo-Liang Tsai, Taipei (TW)

Correspondence Address: BIRCH STEWART KOLASCH & BIRCH, PO BOX 747, FALLS CHURCH, VA, 22040-0747, US

(21) Appl. No.: 09/771,620

(22) Filed: Jan. 30, 2001

(51) Int. Cl. H04R 5/00; H04H 5/00

(52) U.S. Cl. 381/1; 381/11; 381/12; 381/17; 381/18; 700/94

(57) ABSTRACT

The present invention discloses a differential audio device applicable to notebook computers. The device uses differential signal characters to improve the audio signal quality and its transmission distance. The device contains at least an audio controller to output audio signals, a single-ended signal to differential signal converter to convert audio signals into differential signals, a differential signal to single-ended signal converter to convert differential signals into audio signals for output.

### BACKGROUND OF THE INVENTION

1. Field of Invention

The present invention relates to an audio device and, in particular, to a differential audio device.

2. Related Art

In current notebook computer models, the audio output is achieved by using an audio controller to directly transmit audio signals to an audio jack or speaker through a single-ended bus. If the audio jack or speaker is distant from the audio controller, the audio signals are likely to have some noises due to interference, deteriorating the output quality of audio signals.

The signals are transmitted on only one line when using the single-ended signals, therefore they are very sensitive to signal noises. The standard single-ended serial cable can be at most 6 meters long. As the bus uses a higher and higher speed, the signal noises will also increase accordingly. To avoid noise interference, one is forced to shorten the length of the serial cable.

FIG. 1 shows a circuit that transmits the audio output (SE_RIGHT 101 and SE_LEFT 102) from a conventional audio controller line out to an earphone audio (TO_HP_RIGHT 104 and TO_HP_LEFT 105) after the amplification of an amplifier 103. This is a conventional method for single-ended signals. However, the audio output can be easily affected due to too long a circuit or a bad layout.

### SUMMARY OF THE INVENTION

The present invention provides a differential audio device, which uses differential signal characters to improve the audio signal quality and its transmission distance. The device contains at least an audio controller to output a single-ended right audio signal and a single-ended left audio signal; a single-ended signal to differential signal converter to separately convert the single-ended right audio signal and the single-ended left audio signal into differential signals; a differential signal to single-ended signal converter to separately convert the differential signals into the single-ended right audio signal and the single-ended left audio signal.

### BRIEF DESCRIPTION OF THE DRAWINGS

The present invention will become more fully understood from the detailed description given hereinbelow illustration only, and thus are not limitative of the present invention, and wherein:

FIG. 1 is a schematic block diagram of a conventional audio signal output from a notebook computer;

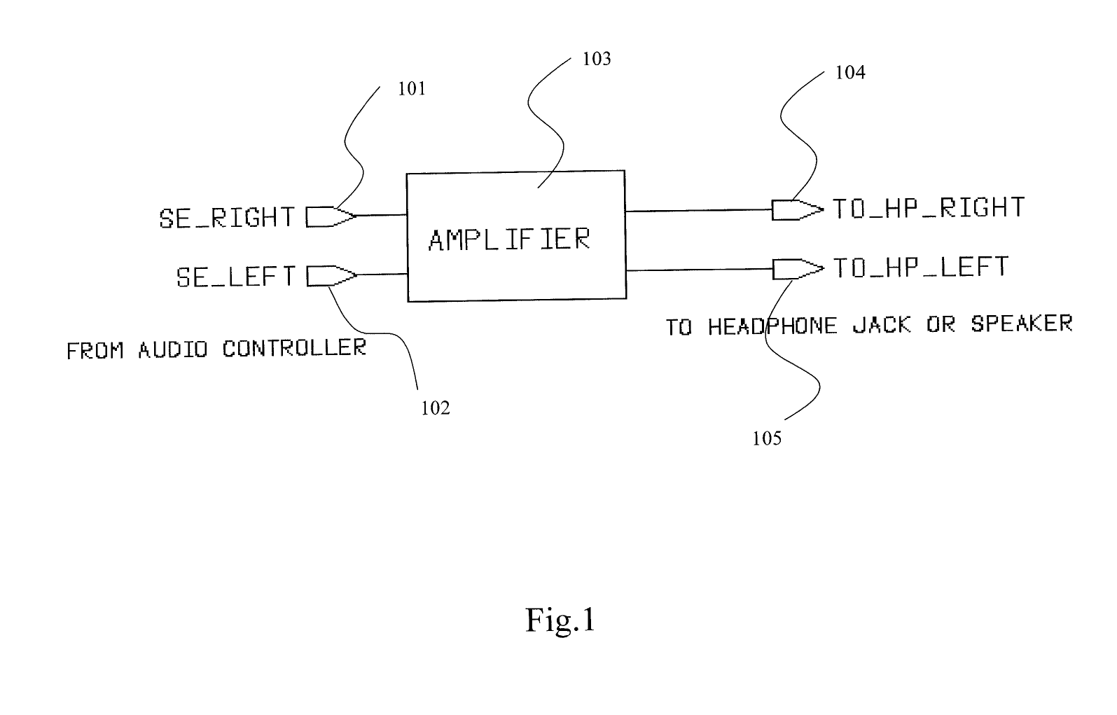

FIG. 2 is a schematic block diagram that converts single-ended signals into differential signals for a notebook computer according to the present invention;

FIG. 2A is a schematic view of the single-ended signal to differential signal conversion circuit for a notebook computer according to according to the present invention;

FIG. 3 is a schematic block diagram that converts differential signals into single-ended signals for a notebook computer according to the present invention; and

FIG. 3A is a schematic view of the differential signal to single-ended signal conversion circuit for a notebook computer according to according to the present invention.

### DETAILED DESCRIPTION OF THE INVENTION

The audio signal in a notebook computer is usually transmitted in the single-ended format. The present invention proposes a differential data transmission that uses two circuits to transmit data. One circuit is the same as in the single-ended transmission, while the other is used to compare the correctness of the data being transmitted. Based upon this property, one does not need to worry too much about noises in the differential signals. Therefore, a longer serial cable is permitted. The standard length is about 25 meters. From purely theoretical point of view, the differential data transmission would be a better choice.

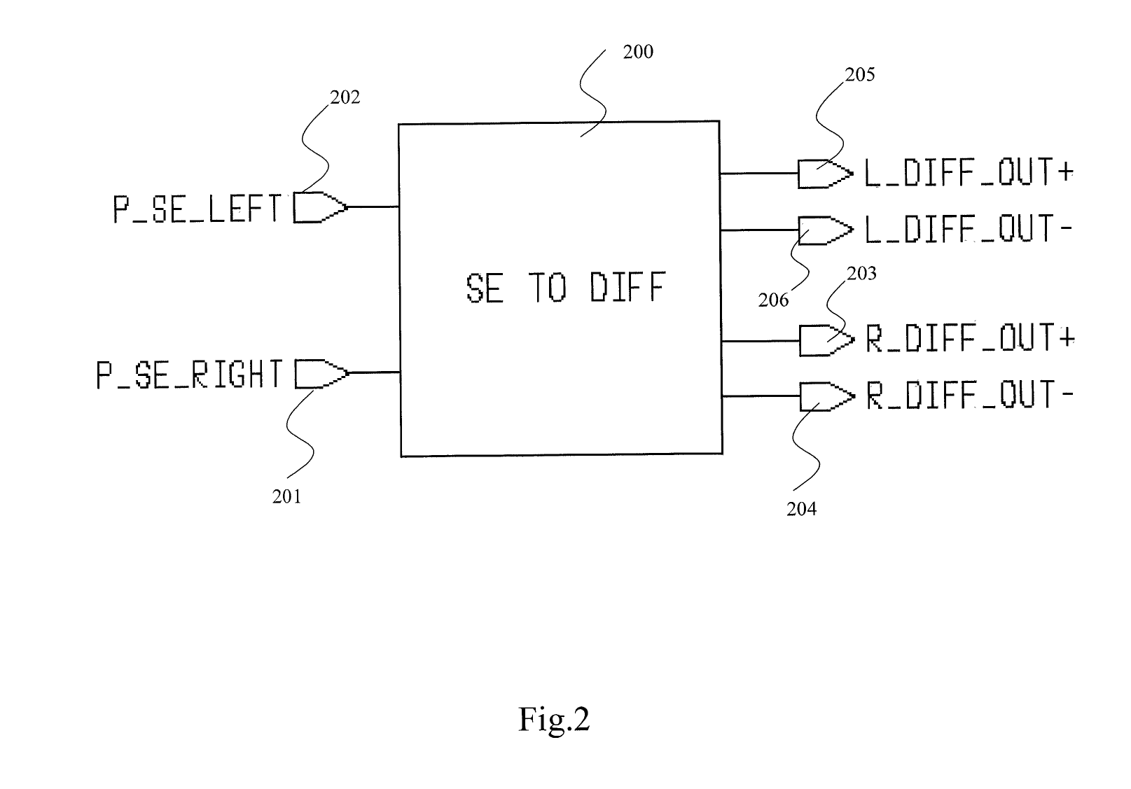

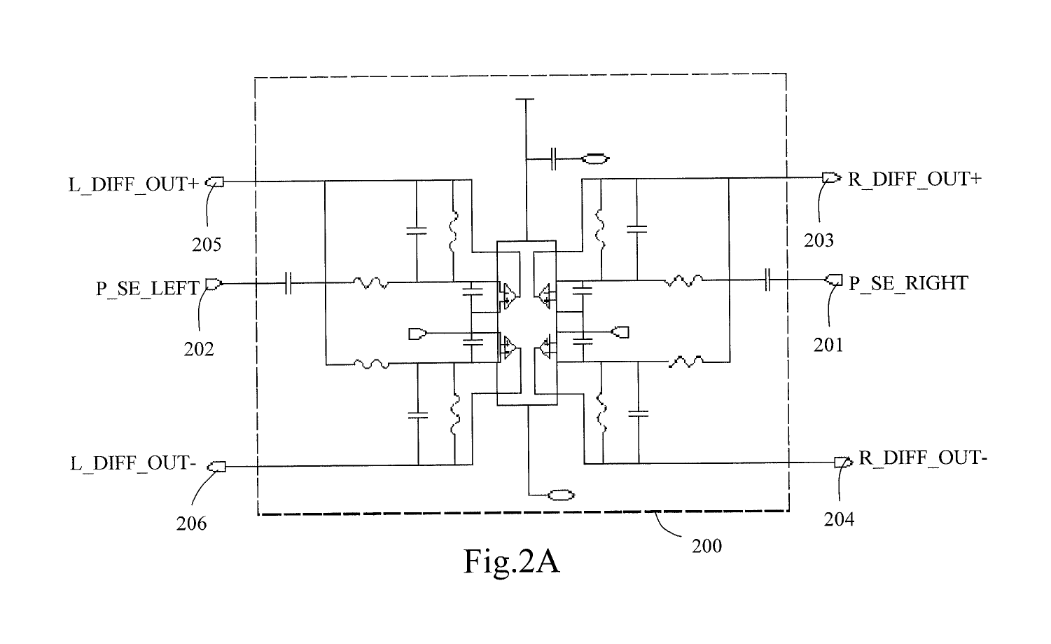

The present invention first passes analogue audio single-ended output signal through a single-ended signal to differential signal converter 200 to convert the single-ended signal into a differential signal. With reference to FIG. 2, the circuit diagram is schematically shown in FIG. 2A. The single-ended right audio output P_SE_RIGHT 201 and the single-ended left audio output P_SE_LEFT 202 are converted into differential signals through the single-ended signal to differential signal converter 200, wherein each single-ended signal is converted into two differential signals. Therefore, after the conversion there are a first differential right audio output R_DIFF_OUT+203, a second differential right audio output R_DIFF_OUT-204, a first differential left audio output L_DIFF_OUT+205, and a second differential left audio output L_DIFF_OUT-206.

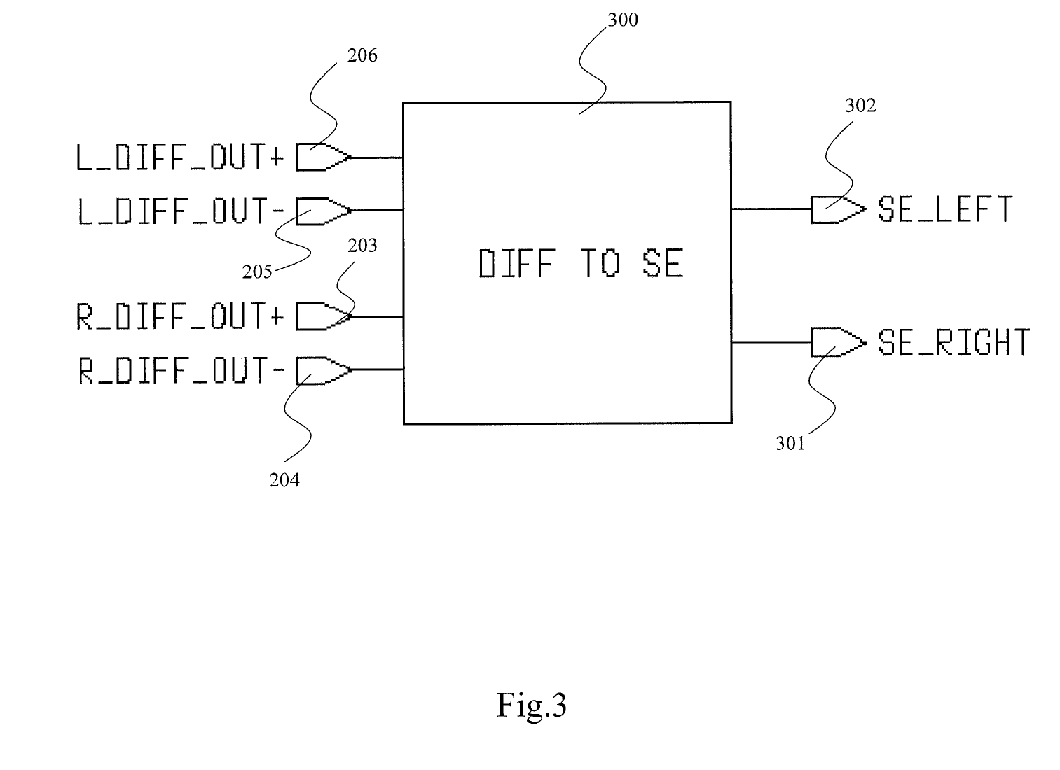

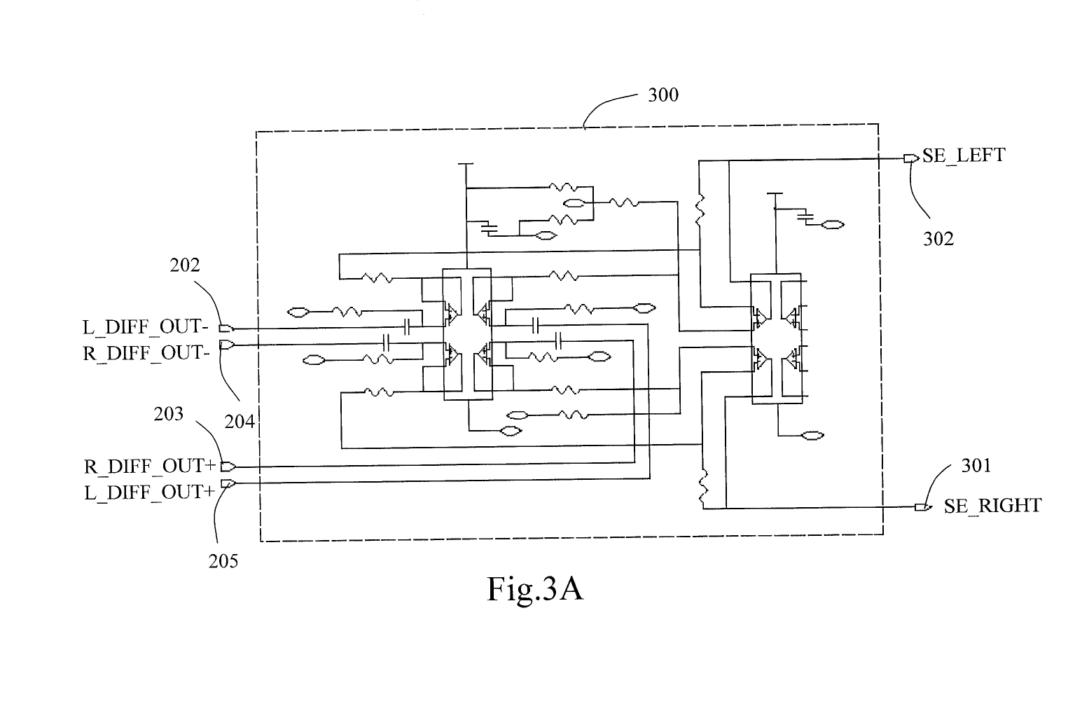

After the conversion of the single-ended signal to differential signal converter 200, the differential signals 203, 204, 205, 206 can present a better transmission quality and a longer transmission distance. When the differential signals 203, 204, 205, 206 are transmitted to an audio jack, a speaker or an earphone, a differential signal to single-ended signal converter 300 is employed to convert the differential signals 203, 204, 205, 206 into a single-ended right audio output SE_RIGHT 301 and a single-ended left audio output SE_LEFT 302 (FIG. 3).

Certain variations would be apparent to those skilled in the art, which variations are considered within the spirit and scope of the claimed invention.

What is claimed is:

1. A differential audio device for applications in notebook computers, which comprises:
an audio controller, which outputs a single-ended right audio signal and a single-ended left audio signal;
a single-ended signal to differential signal converter, which separately converts the single-ended right audio signal and the single-ended left audio signal into differential audio signals; and
a differential signal to single-ended signal converter, which separately converts the differential audio signals into the single-ended right audio signal and the single-ended left audio signal.

2. The device of claim 1, wherein the differential audio signal further comprises a first differential right audio signal.

3. The device of claim 1, wherein the differential audio signal further comprises a second differential right audio signal.

4. The device of claim 1, wherein the differential audio signal further comprises a first differential left audio signal.

5. The device of claim 1, wherein the differential audio signal further comprises a second differential left audio signal.

6. The device of claim 1 further comprising a peripheral device to play the audio signal.

7. The device of claim 6, wherein the peripheral device is an audio jack.

8. The device of claim 6, wherein the peripheral device is a speaker.

9. The device of claim 6, wherein the peripheral device is an earphone.
